(19) United States
(12) Patent Application Publication
(10) Pub. No.: US 2026/0253369 A1
(43) Pub. Date: Aug. 27, 2026

(54) IMAGE PROCESSING SYSTEM AND IMAGE PROCESSING METHOD

(71) Applicant: VIA Technologies, Inc., New Taipei City (TW)

(72) Inventor: Cheng Yu Wen, New Taipei City (TW)

(73) Assignee: VIA Technologies, Inc., New Taipei City (TW)

(21) Appl. No.: 19/186,667

(22) Filed: Apr. 23, 2025

(30) Foreign Application Priority Data
Feb. 25, 2025 (TW) 114106856

(51) Int. Cl. G06V 10/44; G06T 5/80; G06V 10/82

(52) U.S. Cl. CPC G06V 10/44; G06T 5/80; G06V 10/82

(57) ABSTRACT

Provided are an image processing system and an image processing method. The image processing system includes a storage device and a processor. The storage device is configured to store an image preprocessing module and an image conversion module. The processor is coupled to the storage device and configured to execute the image preprocessing module and the image conversion module. The image preprocessing module is configured to perform an image preprocessing on multiple captured images to generate multiple preprocessed images. The image conversion module is configured to execute a bird’s eye view model to generate a bird’s eye view image recognition result based on the multiple preprocessed images. The bird’s eye view image recognition result includes a range of each object recognized in a bird’s eye view. The bird’s eye view model includes performing a feature extraction and a dimension permutation on the multiple preprocessed images.

### CROSS-REFERENCE TO RELATED APPLICATION

This application claims the priority benefit of Taiwan application serial no. 114106856, filed on February 25, 2025. The entirety of the above-mentioned patent application is hereby incorporated by reference herein and made a part of this specification.

### BACKGROUND

### Technical Field

The disclosure relates to a data processing technology, and in particular relates to an image processing system and an image processing method.

### Related Art

In order to allow the vehicle driver to effectively grasp the traffic conditions surrounding the vehicle, current driving assistance may display images surrounding the vehicle through multiple vehicle-mounted cameras for the driver to view. However, the vehicle-mounted cameras currently configured to obtain images surrounding the vehicle mostly use fisheye cameras with a wide-angle field of view, resulting in severe image distortion problems in most of the displayed driving images, which does not facilitate vehicle drivers to effectively determine the traffic conditions. More importantly, a manner that merely displays images surrounding the vehicle does not allow vehicle drivers to effectively grasp the distance and relationship of relative positions between the vehicle and surrounding objects.

### SUMMARY

The disclosure provides an image processing system and an image processing method, which can be applied to driving assistance and can effectively generate a bird’s eye view image.

The image processing system of the disclosure includes a storage device and a processor. The storage device is configured to store an image preprocessing module and an image conversion module. The processor is coupled to the storage device and is configured to execute the image preprocessing module and the image conversion module. The image preprocessing module is configured to perform an image preprocessing on multiple captured images to generate multiple preprocessed images. The image conversion module is configured to execute a bird’s eye view model to generate a bird’s eye view image recognition result based on the preprocessed images. The bird’s eye view image recognition result includes a range of each object recognized in a bird’s eye view. The bird’s eye view model includes performing a feature extraction and a dimension permutation on the preprocessed images.

The image processing method of the disclosure includes the following steps: an image preprocessing is performed on multiple captured images through an image preprocessing module to generate multiple preprocessed images; and a bird’s eye view model is executed through an image conversion module to generate a bird’s eye view image recognition result based on the preprocessed images. The bird’s eye view image recognition result includes a range of each object recognized in a bird’s eye view. The bird’s eye view model includes performing a feature extraction and a dimension permutation on the preprocessed images.

Based on the above, the image processing system and the image processing method of the disclosure can perform the image preprocessing, the feature extraction and the dimension permutation on the multiple captured images to generate a good bird’s eye view image.

In order to make the features and advantages of the disclosure more comprehensible, the following examples are given and described in detail with the accompanying drawings as follows.

### BRIEF DESCRIPTION OF THE DRAWINGS

FIG. 1 is a schematic diagram of an image processing system according to an embodiment of the disclosure.

FIG. 2 is a schematic diagram of multiple modules according to an embodiment of the disclosure.

FIG. 3 is a flow chart of an image processing method according to an embodiment of the disclosure.

FIG. 4 is a schematic diagram of an image preprocessing according to an embodiment of the disclosure.

FIG. 5A and FIG. 5B are schematic diagrams of a feature extraction and a dimension permutation according to an embodiment of the disclosure.

FIG. 6A to FIG. 6D are schematic diagrams of multiple captured images according to an embodiment of the disclosure.

FIG. 6E is a schematic diagram of a bird’s eye view image recognition result according to an embodiment of the disclosure.

FIG. 6F is a schematic diagram of an actual bird’s eye view image according to an embodiment of the disclosure.

### DESCRIPTION OF THE EMBODIMENTS

In order to make the content of the disclosure more comprehensible, embodiments in which the disclosure may be implemented are listed as follows. In addition, wherever possible, elements/components/steps with the same reference numerals in the drawings and embodiments represent the same or similar components.

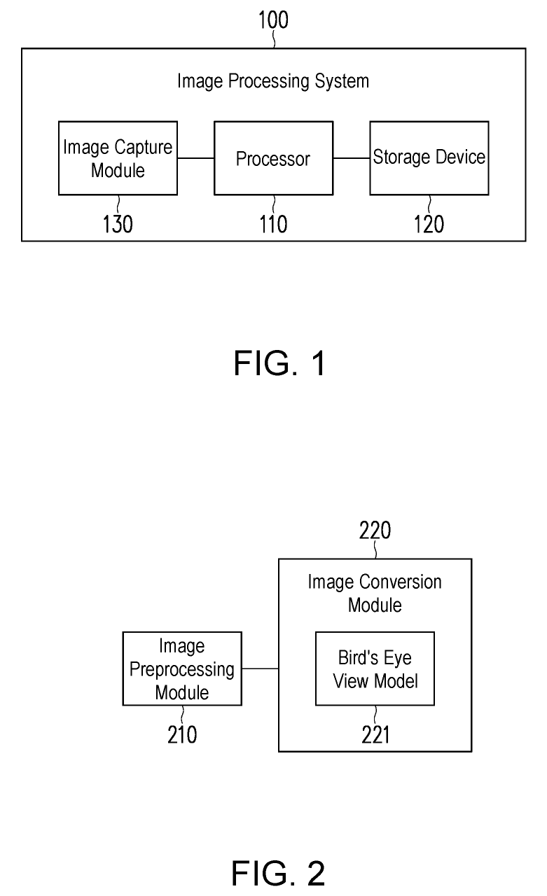

FIG. 1 is a schematic diagram of an image processing system according to an embodiment of the disclosure. Referring to FIG. 1, an image processing system 100 includes a processor 110, a storage device 120, and an image capture module 130. The processor 110 is coupled to the storage device 120 and the image capture module 130. In the embodiment, the image processing system 100 may be disposed in a vehicle, and may be, for example, an advanced driver assistance system (ADAS) or a dashcam. In an embodiment, the image processing system 100 may not include the image capture module 130. The processor 110 and the storage device 120 may be integrated into a single device. In the embodiment, the image capture module 130 may include multiple cameras, which capture images respectively towards different directions to obtain multiple captured images.

For example, the multiple cameras may be multiple fisheye cameras. The multiple fisheye cameras may be respectively disposed at different locations on a vehicle body, and respectively perform image capturing towards a front, a rear, a left, and a right to generate multiple fisheye images. In the embodiment, the processor 110 may utilize the multiple fisheye images to generate a corresponding bird’s eye view image. In an embodiment, the image processing system 100 may further include a display device, which is configured to display the bird’s eye view image.

In the embodiment, the processor 110 may be, for example, a central processing unit (CPU), or other programmable general-purpose or special-purpose microprocessors, digital signal processors (DSP), image processing units (IPU), graphics processing units (GPU), programmable controllers, application specific integrated circuits (ASIC), programmable logic devices (PLD), other similar processing devices, or a combination of the devices.

In the embodiment, the storage device 120 may be, for example, a dynamic random access memory (DRAM), flash memory, or non-volatile random access memory (NVRAM), etc.

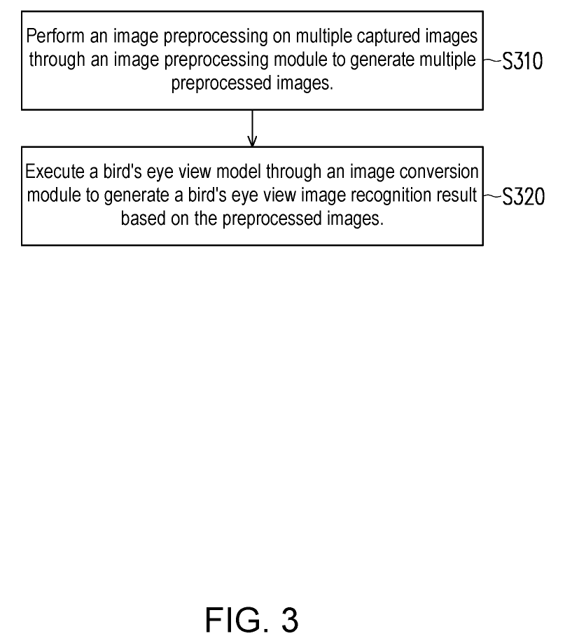

FIG. 2 is a schematic diagram of multiple modules according to an embodiment of the disclosure. FIG. 3 is a flow chart of an image processing method according to an embodiment of the disclosure. Referring to FIG. 1 to FIG. 3, in the embodiment, the storage device 120 may store an image preprocessing module 210 and an image conversion model 220, which may be read and executed by the processor 110 to perform the following steps S310 and S320. In the embodiment, the image capture module 130 may obtain multiple captured images at the same time through multiple cameras. In step S310, the processor 110 performs an image preprocessing on the multiple captured images through the image preprocessing module 210 to generate multiple preprocessed images. In the embodiment, the multiple captured images may be multiple fisheye images, so the image preprocessing module 210 may perform an anti-fisheye preprocessing on the fisheye images. In other embodiments, the multiple cameras may also be other types of cameras besides the fisheye cameras, and the image preprocessing module 210 may also perform other preprocessing besides the anti-fisheye preprocessing on the multiple captured images.

In step S320, the processor 110 executes a bird’s eye view (BEV) model 221 through the image conversion module 220 to generate a bird’s eye view image recognition result based on the preprocessed images. In the embodiment, the BEV model 221 may be pre-trained by multiple captured images and multiple corresponding collected data generated by a lidar system. The BEV model 221 is trained by collected data that annotate a distance of a neighboring object using the lidar system. In this regard, the lidar system may pre-establish the collected data similar to the bird’s eye view image as a ground truth, and annotate the distance and identification information of the neighboring object to train the BEV model 221 to generate the bird’s eye view image recognition result based on an input captured image. Therefore, the BEV model 221 may effectively divide an appropriate range of the object in the bird’s eye view image. In this way, the lidar system only needs to be used to perform an annotation during a training stage of the BEV model 221. Subsequently, when the trained BEV model 221 is provided for an individual vehicle driver to use, the vehicle does not need to install the lidar system, which may reduce costs. The specific implementation details of the image preprocessing module 210 and the image conversion module 220 will be described in detail in the following multiple embodiments.

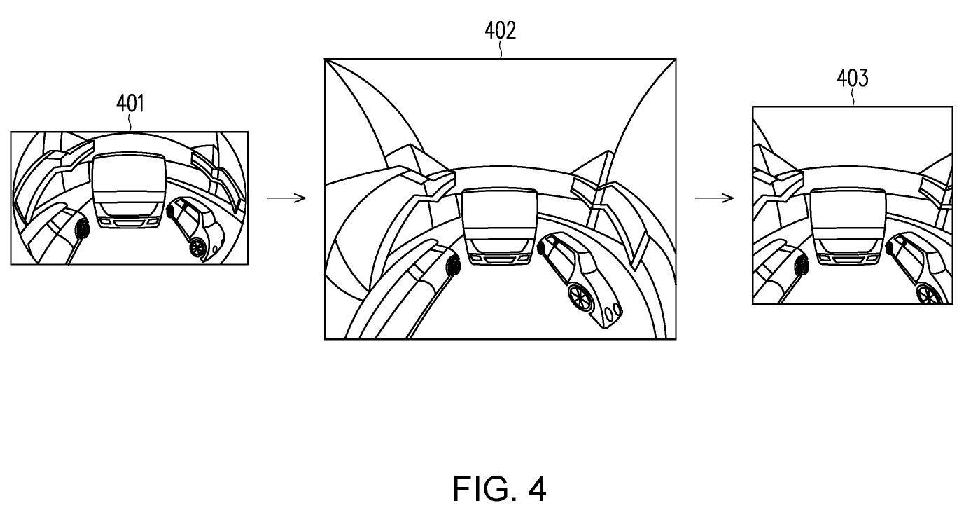

FIG. 4 is a schematic diagram of an image preprocessing based on an embodiment of the disclosure. Referring to FIG. 1, FIG. 2 and FIG. 4, the following description takes a single captured image as an example. In the embodiment, the image capture module 130 may obtain a captured image 401 as shown in FIG. 4. The image preprocessing module 210 may perform an anti-fisheye preprocessing on the captured image 401 to generate an image 402 as shown in FIG. 4. In an embodiment, the image preprocessing module 210 may use a radial distortion model to execute a radial distance correction formula to correct a deformation caused by a focal length of the lens and a field of view. Moreover, the image preprocessing module 210 may utilize a polar coordinate transformation to process a polar distortion in the captured image 401 (a fisheye image) to convert into orthogonal plane coordinates. Furthermore, the image preprocessing module 210 may take a difference method to reconstruct a target image (that is, the generated image 402) to ensure the reasonableness of pixel values and the image quality. Next, the image preprocessing module 210 may crop the image 402 to obtain a preprocessed image 403.

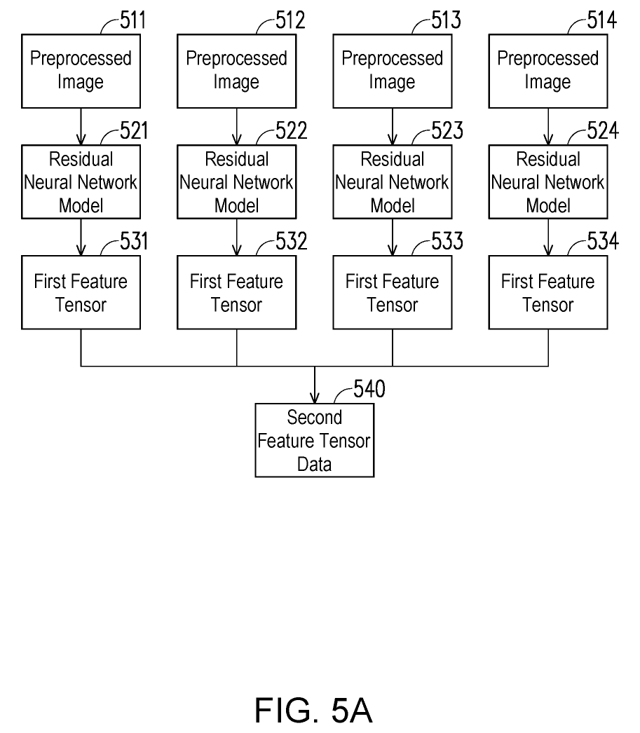

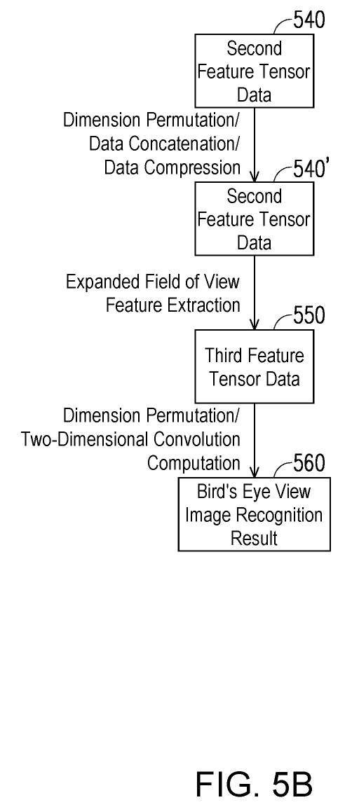

FIG. 5A and FIG. 5B are schematic diagrams of a feature extraction and a dimension permutation according to an embodiment of the disclosure. Referring to FIG. 1, FIG. 2 and FIG. 5A, in the embodiment, the image capture module 130 may include four fisheye cameras, and respectively perform image capturing towards a front, a rear, a left, and a right of the vehicle to obtain four captured images. The image preprocessing module 210 may execute the anti-fisheye preprocessing as described in the foregoing embodiment on the four captured images to obtain preprocessed images 511 to 514. The preprocessed images 511 to 514 may, for example, respectively be images with a resolution of 960×540. In other embodiments, the image capture module 130 may also include other numbers or types of cameras depending on needs.

Next, the bird’s eye view model 221 may respectively input the preprocessed images 511 to 514 into multiple residual neural network (ResNet) models 521 to 524 to perform a feature extraction, and output multiple first feature tensors 531 to 534. The first feature tensors 531 to 534 are respectively feature map tensors. The first feature tensors 531 to 534 may, for example, respectively include tensors of four dimensions. The four dimensions are quantity (i.e., batch size), height, width, and channel information. The first feature tensors 531 to 534 may, for example, be feature map tensors of [1,160,135,256]. Next, the bird’s eye view model 221 may perform a concatenation on the first feature tensors 531 to 534 to generate a second feature tensor data 540 (such as performing the concatenation on the channel dimension). The second feature tensor data 540 may, for example, be a feature map tensor of [1,160,135,1024].

Referring to FIG. 1, FIG. 2 and FIG. 5B, next, the bird’s eye view model 221 performs a dimension permutation on the second feature tensor data 540, and performs a data concatenation and a data compression on the second feature tensor data after the dimension permutation to generate a second feature tensor data 540’. In the embodiment, the bird’s eye view model 221 may perform the permutation on a height information dimension and a quantity information dimension in the second feature tensor data 540 to generate the second feature tensor data after the dimension permutation. Alternatively, in an embodiment, the bird’s eye view model 221 may perform the permutation on a width information dimension and the quantity information dimension in the second feature tensor data 540 to generate the second feature tensor data after the dimension permutation. In a subsequent two-dimensional convolution computation of the feature extraction, the problem that extracted features of objects at different distances may be different in size may be avoided in the second feature tensor data after the dimension permutation, improving the accuracy of the generated bird’s eye view.

In this regard, the bird’s eye view model 221 may, for example, convert the feature map tensor of [1,160,135,1024] (quantity, height, width, channel) to a feature map tensor of [160,1,135,1024] (height, quantity, width, channel). Alternatively, the bird’s eye view model 221 may, for example, convert the feature map tensor of [1,160,135,1024] (quantity, height, width, channel) to a feature map tensor of [135,160,1,1024] (width, height, quantity, channel).

Next, the bird’s eye view model 221 may perform a concatenation on the second feature tensor data after the dimension permutation with its own data or a tensor data of a previous time point (such as a previous timestamp). In this regard, if the current second feature tensor data after the dimension permutation is a data of an initial time point, the bird’s eye view model 221 may perform the concatenation on the second feature tensor data after the dimension permutation with its own data (i.e., the second feature tensor data after the dimension permutation is concatenated with an identical copy of itself) to generate, for example, a feature map tensor of [1,160,135,2048]. Alternatively, if the current second feature tensor data after the dimension permutation is a data of a non-initial time point, the bird’s eye view model 221 may perform the concatenation on the second feature tensor data after the dimension permutation with the tensor data of the previous time point to generate, for example, a feature map tensor of [1,160,135,2048].

Next, the bird’s eye view model 221 may perform a data compression to generate the second feature tensor data 540’. The second feature tensor data 540’ may be a feature map tensor of [1,160,135,1024]. The bird’s eye view model 221 may perform an expanded field-of-view feature extraction on the second feature tensor data 540’ to generate a third feature tensor data 550. In the embodiment, the bird’s eye view model 221 may extract features from the second feature tensor data 540’ through a multi-scale feature extraction module (such as Inception module) to generate the third feature tensor data 550. The multi-scale feature extraction module may be composed of multiple different scales of two-dimensional convolutional neural computation (Conv2D) layers and pooling layers. The steps of the data compression in the embodiment is mainly determined by a size of the second feature tensor data and an input size of the multi-scale feature extraction module. In other embodiments, the data compression may not be performed, and the expanded field-of-view feature extraction is directly performed on the second feature tensor data 540.

Next, the bird’s eye view model 221 may perform the permutation on the dimensions of the third feature tensor data 550 again to restore an original dimension order thereof. In this regard, the bird’s eye view model 221 may, for example, convert the third feature tensor data 550 back to the feature map tensor of [1,160,135,1024] (quantity, height, width, channel) that is consistent with the dimension order of the original second feature tensor data 540. The bird’s eye view model 221 may perform the two-dimensional convolutional neural computation that extracts partial features multiple times on the third feature tensor data 550 after the dimension permutation to generate, for example, a tensor data of [1,20,17,class]. Moreover, the bird’s eye view model 221 may perform a scaling or resampling process to generate, for example, a tensor data of class of [1,H,W,class] having a specific height (H) and a specific width (W), and generate a bird’s eye view image recognition result 560 accordingly. The scaling or resampling process in the embodiment may be designed depending on a height, width, and number of classes of an output tensor data needed, and may be omitted in other embodiments. An appropriate object range and object class may be divided in the bird’s eye view image recognition result 560. Therefore, the image processing system 100 of the embodiment may effectively generate the bird’s eye view image recognition result 560 for the driver to view and pay attention to object conditions near the vehicle.

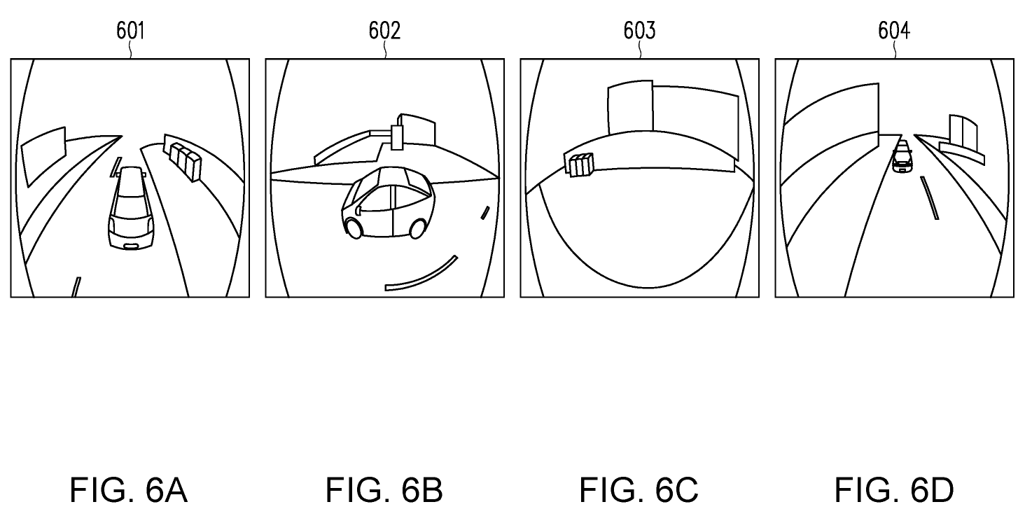

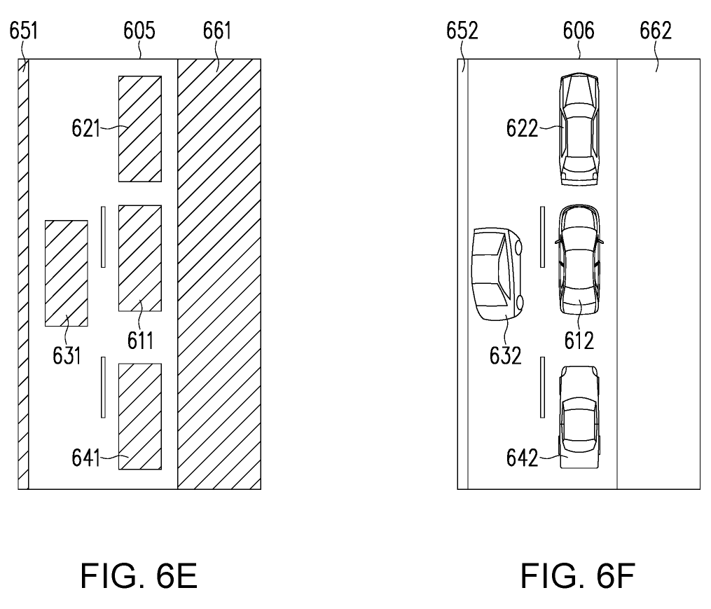

FIG. 6A to FIG. 6D are schematic diagrams of multiple captured images of an embodiment of the disclosure. FIG. 6E is a schematic diagram of a bird’s eye view image recognition result of an embodiment of the disclosure. FIG. 6F is a schematic diagram of an actual bird’s eye view image of an embodiment of the disclosure. For example, referring to FIG. 1, FIG. 2, FIG. 6A to FIG. 6F, the image processing system 100 may obtain a captured image 601 in front of a vehicle, a captured image 602 on a left side of the vehicle, a captured image 603 on a right side of the vehicle, and a captured image 604 behind the vehicle through the image capture module 130. The image preprocessing module 210 may first perform an anti-fisheye preprocessing on the captured images 601 to 604. The image conversion module 220 may perform the feature extraction, the dimension permutation, and related image processing as described in the foregoing embodiment through the bird’s eye view model 221 to generate a bird’s eye view image recognition result 605 as shown in FIG. 6E. The bird’s eye view image recognition result 605 may include a range, a distance, or a class of each object recognized in the bird’s eye view. Comparing the bird’s eye view image recognition result 605 with an actual bird’s eye view image 606 in FIG. 6F, the bird’s eye view image recognition result 605 may correspondingly display object ranges 611, 621, 631 and 641 corresponding to locations of a vehicle body 612, a front vehicle 622, a left vehicle 632, and a rear vehicle 642. Moreover, the bird’s eye view image recognition result 605 may further display corresponding object ranges 651 and 661 for locations of environmental objects such as a fence 652 and a lawn 662. Therefore, the vehicle driver may effectively grasp the situation around the vehicle by viewing the bird’s eye view image recognition result 605. In an embodiment, the image processing system 100 may provide the distance, the range, or the class of each object in the bird’s eye view image recognition result 605 to the assisted driving system of the vehicle to remind the driver to pay attention to safety risks or take safety measures, or combine with the actual bird’s eye view image 606 for the vehicle driver to view.

In summary, the image processing system and the image processing method of the disclosure may effectively precisely generate corresponding bird’s eye view image recognition results based on real-time vehicle surrounding images obtained by multiple cameras to allow the vehicle driver to effectively grasp the condition surrounding the vehicle. When used by the vehicle driver, the vehicle does not need to install a lidar system, which can save costs.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An image processing system, comprising:
a storage device, configured to store an image preprocessing module and an image conversion module; and
a processor, coupled to the storage device, and configured to execute the image preprocessing module and the image conversion module,
wherein the image preprocessing module is configured to perform an image preprocessing on a plurality of captured images to generate a plurality of preprocessed images, and the image conversion module is configured to execute a bird’s eye view model to generate a bird’s eye view image recognition result based on the preprocessed images, and the bird’s eye view image recognition result comprises a range of each object recognized in a bird’s eye view,
wherein the bird’s eye view model comprises performing a feature extraction and a dimension permutation on the preprocessed images.

2. The image processing system according to claim 1, wherein the bird’s eye view model is trained by collected data that annotate a distance of a neighboring object using a lidar system.

3. The image processing system according to claim 1, wherein the captured images are a plurality of fisheye images, and the image preprocessing module is configured to perform an anti-fisheye preprocessing on the fisheye images.

4. The image processing system according to claim 1, wherein the bird’s eye view model generates a plurality of first feature tensors based on the preprocessed images, and the bird’s eye view model performs a concatenation on the first feature tensors to generate a second feature tensor data,
wherein the bird’s eye view model performs the feature extraction on the second feature tensor data to generate a third feature tensor data, and the bird’s eye view model performs a two-dimensional convolution computation on the third feature tensor data to generate the bird’s eye view image recognition result.

5. The image processing system according to claim 4, wherein the bird’s eye view model inputs the preprocessed images into a residual neural network model to generate the first feature tensors.

6. The image processing system according to claim 4, wherein the bird’s eye view model performs the dimension permutation on the second feature tensor data.

7. The image processing system according to claim 6, wherein the bird’s eye view model performs a permutation on a height information dimension and a quantity information dimension in the second feature tensor data to generate the second feature tensor data after the dimension permutation.

8. The image processing system according to claim 6, wherein the bird’s eye view model performs a permutation on a width information dimension and a quantity information dimension in the second feature tensor data to generate the second feature tensor data after the dimension permutation.

9. The image processing system according to claim 6, wherein the bird’s eye view model performs a concatenation on the second feature tensor data after the dimension permutation with its own data or a tensor data of a previous time point to perform the feature extraction.

10. The image processing system according to claim 4, wherein the bird’s eye view model performs the dimension permutation on the third feature tensor data, and performs a two-dimensional convolution computation that extracts partial features on the third feature tensor data after the dimension permutation to generate the bird’s eye view image recognition result.

11. An image processing method, comprising:
performing an image preprocessing on a plurality of captured images through an image preprocessing module to generate a plurality of preprocessed images; and
executing a bird’s eye view model through an image conversion module to generate a bird’s eye view image recognition result based on the preprocessed images, wherein the bird’s eye view image recognition result comprises a range of each object recognized in a bird’s eye view,
wherein the bird’s eye view model comprises performing a feature extraction and a dimension permutation on the preprocessed images.

12. The image processing method according to claim 11, wherein the bird’s eye view model is trained by collected data that annotate a distance of a neighboring object using a lidar system.

13. The image processing method according to claim 11, wherein the captured images are a plurality of fisheye images, and steps of performing the image preprocessing on the captured images comprise:
performing an anti-fisheye preprocessing on the fisheye images through the image preprocessing module.

14. The image processing method according to claim 11, wherein steps of executing the bird’s eye view model to generate the bird’s eye view image recognition result based on the preprocessed images comprise:
generating a plurality of first feature tensors based on the preprocessed images;
performing a concatenation on the first feature tensors to generate a second feature tensor data;
performing the feature extraction on the second feature tensor data to generate a third feature tensor data; and
performing a two-dimensional convolution computation on the third feature tensor data to generate the bird’s eye view image recognition result.

15. The image processing method according to claim 14, wherein steps of generating the first feature tensors comprise:
inputting the preprocessed images into a residual neural network model to generate the first feature tensors.

16. The image processing method according to claim 14, wherein the steps of executing the bird’s eye view model to generate the bird’s eye view image recognition result based on the preprocessed images further comprise:
performing the dimension permutation on the second feature tensor data.

17. The image processing method according to claim 16, wherein steps of performing the dimension permutation on the second feature tensor data comprise:
performing a permutation on a height information dimension and a quantity information dimension in the second feature tensor data to generate the second feature tensor data after the dimension permutation.

18. The image processing method according to claim 16, wherein steps of performing the dimension permutation on the second feature tensor data comprise:
performing a permutation on a width information dimension and a quantity information dimension in the second feature tensor data to generate the second feature tensor data after the dimension permutation.

19. The image processing method according to claim 16, wherein the second feature tensor data after the dimension permutation is concatenated with its own data or a tensor data of a previous time point to perform the feature extraction.

20. The image processing method according to claim 14, wherein steps of generating the bird’s eye view image recognition result comprise:
performing the dimension permutation on the third feature tensor data; and
performing the two-dimensional convolution computation that extracts partial features on the third feature tensor data after the dimension permutation to generate the bird’s eye view image recognition result.
